(19) United States
(12) Patent Application Publication
(10) Pub. No.: US 2018/0081618 A1
(43) Pub. Date: Mar. 22, 2018

(54) AUDIO SEGMENT PLAYBACK COORDINATION

(71) Applicant: LENOVO Enterprise Solutions (Singapore) PTE. LTD., New Tech Park (SG)

(72) Inventor: James G. McLean, Raleigh, NC (US)

(21) Appl. No.: 15/268,392

(22) Filed: Sep. 16, 2016

(51) Int. Cl. G06F 3/16; H04L 29/06

(52) U.S. Cl. CPC G06F 3/165; H04L 65/1069

(57) ABSTRACT

An apparatus method and program product are disclosed for audio segment playback coordination. A program module determines one or more program timing windows corresponding to one or more program segments for playing on an audio player device. An announcement module determines an announcement timing window for an announcement segment for playing on the audio player device. A control module that analyzes the one or more program timing windows and the announcement timing window and coordinates the playing of the announcement segment relative to the playing of the one or more program segments to minimize an interruption of the playing of the one or more program segments when playing the announcement segment.

### FIELD

The subject matter disclosed herein relates to audio player devices and more particularly to coordination of playing audio of program segments and announcement segments.

### BACKGROUND

Audio player devices can play audio segments from a wide variety of sources. Audio player devices such as radios and compact disc players may play audio segments in a predetermined order. For example, an audiocassette player and/or a compact disc player may play program segments such as audiobook chapters in a sequential order by track number. Some compact disc players and/or portable media players may play songs in either a sequential order or a random order. A radio may play audio segments including program segments and announcement segments in a predetermined order in which they are broadcast. Some audio player devices that play audio segments from different sources may interrupt playing of program segments to play announcement segments such as navigation instructions, new message notification signals, phone call ring tones, paging message, and the like.

### BRIEF SUMMARY

An apparatus for audio segment playback coordination is disclosed. A method and computer program product also perform the functions of the apparatus. In one embodiment, an apparatus includes a program module that determines one or more program timing windows corresponding to one or more program segments for playing on an audio player device, and an announcement module that determines an announcement timing window for an announcement segment for playing on the audio player device. The apparatus includes a control module that analyzes the one or more program timing windows and the announcement timing window and coordinates the playing of the announcement segment relative to the playing of the one or more program segments to minimize an interruption of the playing of the one or more program segments when playing the announcement segment.

In one embodiment, the one or more program timing windows each include a program segment priority for the one or more program segments and the announcement timing window includes an announcement segment priority for the announcement segment. In some embodiments, the program segment priority and announcement segment priority include a vendor-programmed priority by segment type, a user-programmed priority by segment type, temporary priority by segment type, and/or a user-action-based priority. In some embodiments, analyzing the one or more program timing windows and the announcement timing window includes determining whether the one or more program timing windows overlaps with the announcement timing window and determining the priority of the one or more program segments relative to the announcement segment.

In one embodiment, responsive to a program timing window having a first priority overlapping with an announcement timing window having a second priority, the control module modifies a program segment corresponding to said program timing window when said first priority is less than said second priority or modifies the announcement segment when said second priority is not higher than said first priority. In some embodiments, modifying the one or more program segments comprises one or more of delaying starting, truncating, fading out, repeating a portion of, substituting, switching playing order, time dilating, and editing the one or more program segments. In the embodiments, modifying the announcement segment comprises one or more of delaying starting, truncating, repeating a portion of, time dilating, switching playing order of, and substituting the announcement segment. In one embodiment, the apparatus includes a user input module that receives a program segment priority for a program segment and/or a program segment type, an announcement segment priority for an announcement segment and an announcement segment type, a program segment interruption override, and/or a priority schedule.

In some embodiments, the one or more program segments comprise one or more of a streaming music segment, a streaming audiobook segment, a streaming talk segment, an audio segment on a disk, an audio segment on a solid-state storage device, an AM radio broadcast segment, an FM radio broadcast segment, a satellite broadcast, a wired auxiliary audio source segment, and a wireless auxiliary audio source segment. In some embodiments, the one or more announcement segments include a vehicle warning, a navigation instruction, a phone call notification, a news alert, a text message notification, an email notification, a paging message, an application notification, and/or an advertisement.

In some embodiments, the one or more program timing windows include a scheduled program segment start time, and a program segment duration for the one or more program segments. In further embodiments, the announcement timing window includes an estimated announcement segment start time and an estimated announcement segment duration. In one embodiment, the announcement module interacts with an application providing an announcement segment to determine a schedule for the announcement segment. In another embodiment, the control module interacts with an application to modify one or more of timing of an announcement segment and content of the announcement segment

A method for audio segment playback coordination includes determining one or more program timing windows corresponding to one or more program segments for playing on an audio player device, and determining an announcement timing window for an announcement segment for playing on the audio player device. The method includes analyzing the one or more program timing windows and the announcement timing window and coordinating the playing of the announcement segment relative to the playing of the one or more program segments to minimize an interruption of the playing of the one or more program segments when playing the announcement segment.

In some embodiments, the program segment priority and announcement segment priority include a vendor-programmed priority by segment type, a user-programmed priority by segment type, temporary priority by segment type, and/or a user-action-based priority. In further embodiments, analyzing the one or more program timing windows and the announcement timing window includes determining whether the one or program segments overlap with the announcement timing window and determining the priority of the one or more program segments relative to the announcement segment.

In one embodiment, the method includes modifying the one or more program segments in response to the one or more program timing windows overlapping with the announcement timing window, and the one or more program segments having lower priority than the announcement segment. In the embodiment, the method includes modifying the announcement segment in response to the announcement timing window overlapping with the one or more program timing windows, and the announcement segment not having higher priority than the one or more program segments.

In some embodiments, modifying the one or more program segments comprises one or more of delaying starting, truncating, fading out, repeating a portion of, substituting, switching playing order, time dilating, and editing the one or more program segments, and modifying the announcement segment comprises one or more of delaying starting, truncating, repeating a portion of, time dilating, switching playing order of, and substituting the announcement segment.

In one embodiment, the method includes receiving user input that includes a program segment priority for a program segment and/or a program segment type, an announcement segment priority for an announcement segment and an announcement segment type, a program segment interruption override, and/or a priority schedule.

A program product for audio segment playback coordination includes a computer readable storage medium that stores code executable by a processor, where the executable code includes code to perform determining one or more program timing windows corresponding to one or more program segments for playing on an audio player device, and determining an announcement timing window for an announcement segment for playing on the audio player device. The executable code includes code to perform analyzing the one or more program timing windows and the announcement timing window and coordinating the playing of the announcement segment relative to the playing of the one or more program segments to minimize an interruption of the playing of the one or more program segments when playing the announcement segment.

In some embodiments, coordinating the playing of the announcement segment relative to the playing of the one or more program segments includes modifying the one or more program segments in response to the one or more program timing windows overlapping with the announcement timing window and the one or more program segments having a lower priority than the announcement segment, and modifying the announcement segment in response to the announcement timing window overlapping with the one or more program timing windows and the announcement segment not having a higher priority than the one or more program segments.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for coordinating playing of audio segments;

FIG. 2A is a schematic block diagram illustrating one embodiment of an apparatus for coordinating playing of audio segments;

FIG. 2B is a schematic block diagram illustrating another embodiment of an apparatus for coordinating playing of audio segments;

FIG. 3A is a schematic block diagram illustrating one embodiment of coordinating playing of audio segments;

FIG. 3B is a schematic block diagram illustrating another embodiment of coordinating playing of audio segments;

FIG. 4 is a schematic flow chart diagram illustrating one embodiment of an audio segment playback coordination method; and

FIG. 5 is a schematic flow chart diagram illustrating another embodiment of an audio segment playback coordination method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It may also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code. The description of elements in each figure may refer to elements of proceeding figures. Like numbers refer to like elements in all figures, including alternate embodiments of like elements.

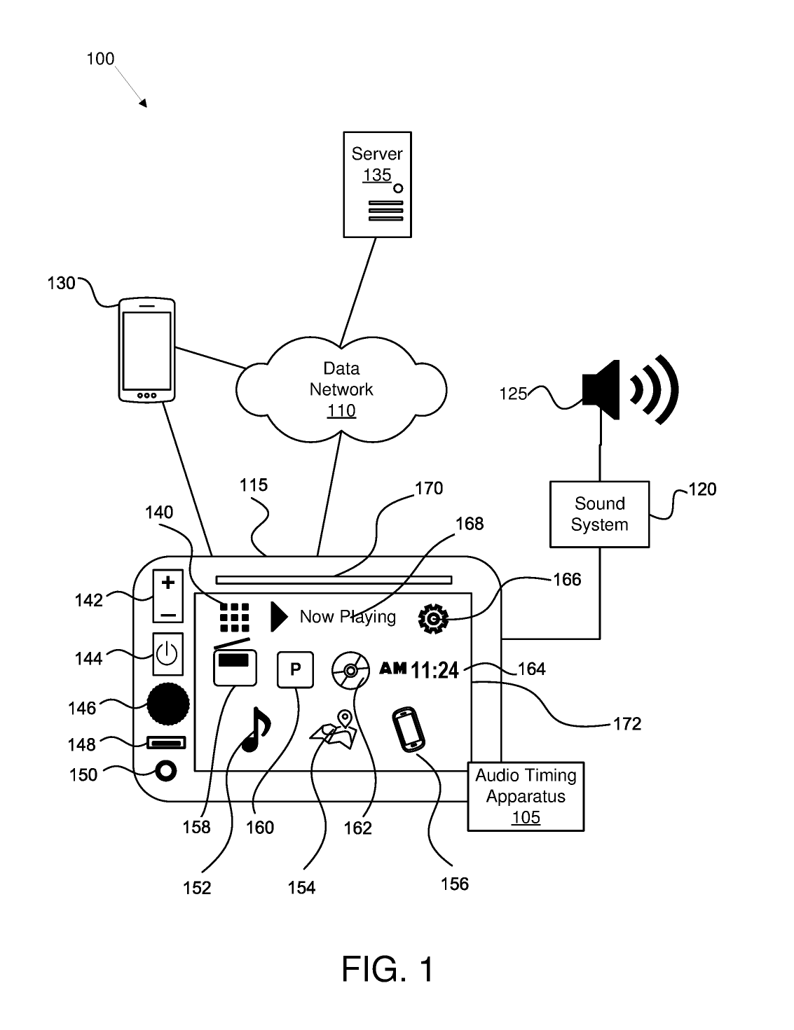

FIG. 1 is a schematic block diagram illustrating one embodiment of a system 100 for coordinating playback of audio segments. The system 100 includes one embodiment of an audio timing apparatus 105, a data network 110, an audio player device 115, a sound system 120, a loudspeaker 125, a computing device 130, and a server 135 which are described below.

Audio player devices may produce audible sounds by playing, or playing back, audio segments. As used herein, the terms “playback” and “playing” refer generally to electronically producing an audible sound. The terms “playback” and “playing” are used herein synonymously unless otherwise clearly expressed in context. As used herein, the terms “playback” and “playing” may refer to electronically reproducing sounds from an audio recording as well as electronically producing sounds from a live performance or speech that may not have been recorded. The terms “playback” and “playing” may further refer to electronically generating sounds using a tone generator, a synthesizer, a buzzer, and the like. The term “audio segment” as used herein may refer to an item of audio content suitable for playing or playback on an audio player device 115.

In one embodiment, the audio player device 115 may be a car stereo that may include an audio player application such as Android Auto® or Apple CarPlay® or may include other vendor specific car stereo applications. The audio player device 115 may include physical control features such as: volume control 142 that is used to control the volume of playback, power control 144 that is used to turn the player device on and off, and/or tuning knob/jog dial 146 that is used to scroll through menu choices such as radio stations or song playback lists. In some embodiments, the audio player device 115 may connect to a computing device 130 such as a smart phone. In some embodiments, the computing device 130 is, or functions as, the audio player device 115.

Although one embodiment depicts examples of an audio player device 115 in an automotive setting, in some embodiments, audio player devices 115 may be used in other venues. For example, in some embodiments, an audio player device 115 may be used in a waiting area such as a waiting room of a medical office. In some embodiments, an audio player device 115 may be used in a public area such as a shopping mall, an airport gate area, a conference center, a church, a museum, a restaurant, and/or any venue where it may be useful to play programs and announcements.

Audio player devices 115 used in such venues may have some of the features or all of the features described above. Some audio player devices 115 for various venues may include additional features for playing one or more program segments PSeg and one or more announcement segments ASeg over an audio channel in common.

In some embodiments, the audio player device 115 may connect to a sound system 120 through a wired or wireless connection. The sound system 120 may connect through a wired or wireless connection one or more loudspeakers or other audio reproduction components such as headphones, earphones, and the like. The one or more loudspeakers 125 produce the sound waves from the audio segments so that listeners may hear both the program segments PSeg and the announcement segments ASeg through a common or shared sound system 120 and one or more loudspeakers 125.

In some embodiments, the audio player device 115 may further include interfaces, such as USB interface 148 that is used to playback media from digital storage devices, auxiliary jack 150 that is used to provide a wired connection to a headphone jack of a mobile phone or portable media player, and media disc slot 170 that is used to insert disk such as compact discs (“CDs”) and digital versatile disks (“DVDs”). In some embodiments, the audio player device 115 may include a touchscreen 172 with an application menu 140 that allow a user to select media applications 152, map applications 154, or phone applications 156.

In media applications 152, the audio player device 115 may be programmed to play programs from various media sources such as for example broadcast radio 158, streaming digital radio 160, digital recording media 162. In some embodiments, the audio player device 115 may include a digital clock/calendar 164 that displays the current time. The digital clock/calendar 164 may also be used to program or schedule particular playback events. In some embodiments, the audio player device 115 may include a configuration setting 166 by which a user may configure the audio player device 115. The audio player device 115 may further include a display 168 that displays information about a currently playing audio segment.

In some embodiments, the audio player device 115 may establish a wireless connection with a computing device 130 such as for example a smart phone. In some environments the audio player device 115 may connect with a server 135 and/or with another audio player device 115. The server 135 may serve audio content including program segments PSeg and announcement segments ASeg to an audio player device 115 through a data network 110 using a wired connection 116 or a wireless connection. The audio player device 115 may also connect with the computing device 130 through a wireless connection. The wireless connection may be used to connect to and/or transfer data related to digital media content, Internet application sites, configuration data, account data, and so forth.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials (“ASTM”), the DASH? Alliance, and EPCGlobal.

Alternatively, the wireless connection may employ a ZigBee connection based on the IEEE 802 standard. In one embodiment, the wireless connection employs a Z-Wave connection as designed by Sigma Designs. Alternatively, the wireless connection may employ an ANT and/or ANT+ connection as defined by Dynastream Innovations Inc. of Cochrane, Canada.

The wireless connection may be an infrared connection including connections conforming at least to the Infrared Physical Layer Specification (“IrPHY”) as defined by the Infrared Data Association (“IrDA”). Alternatively, the wireless connection may be a cellular telephone network communication. All standards and/or connection types include the latest version and revision of the standard and/or connection type as of the filing date of this application.

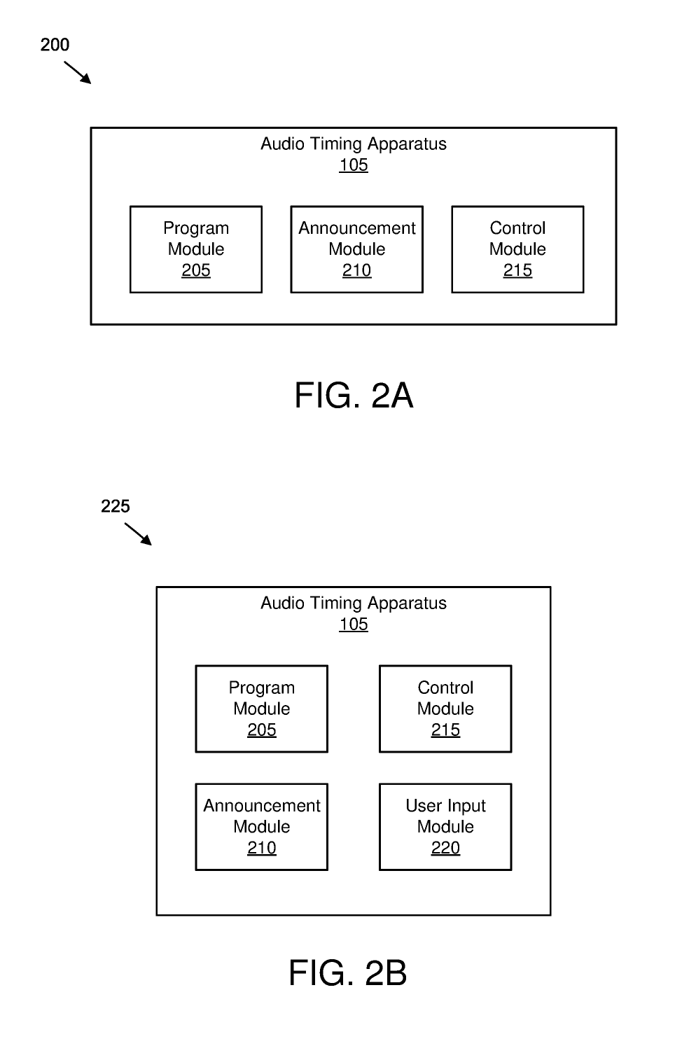

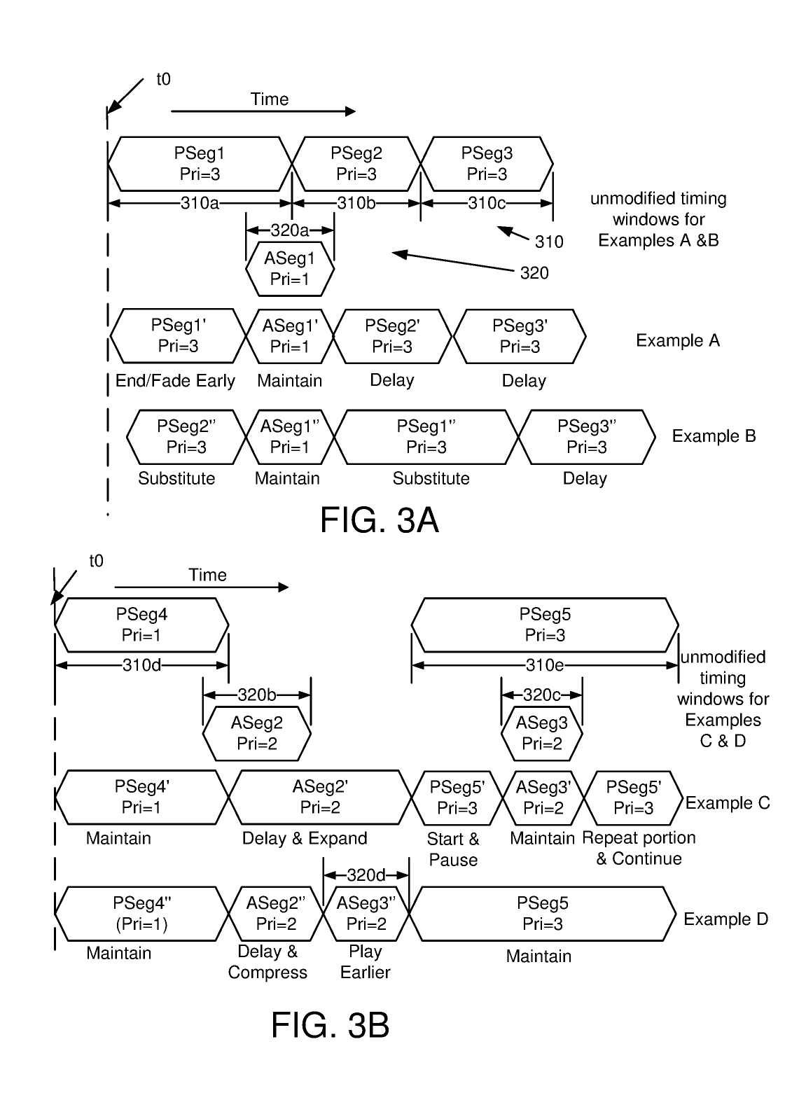

FIG. 2A is a schematic block diagram illustrating one embodiment of an apparatus 200 for coordinating playback of audio segments. The apparatus 200 includes one embodiment of an audio timing apparatus 105 with an audio timing apparatus 105 that includes a program module 205, an announcement module 210, and a control module 215, which are described below. To better understand the naming conventions used to depict the relative timing of audio segments and more specifically program segments PSeg and announcement segments ASeg, it may be useful to refer briefly to FIG. 3A.

A first type of audio segment, referred to herein as a program segment (“PSeg”), may include items of audio content for an audio program such as songs, audiobook paragraphs and chapters, news stories, monologues, discussions, phone conversations, and the like. A second type of audio segment, referred to herein as an Announcement Segment (“ASeg”), may include items of audio content intended as an announcement, a signal, an alert, or similar sound or sounds. For example, an audio segment may be a tone, a buzz, a beep, a spoken instruction, an alarm, musical notes, a song, a portion of a song, an advertisement, and so forth. Some program segments PSeg may be intended to provide entertaining audio content. An announcement segment ASeg may be intended to provide information. However, some program segments PSeg, such as for example, audiobooks or broadcasts may provide information that may or may not be entertaining to a particular listener.

Often, a program segment PSeg may be longer than announcement segment ASeg. For example, a frequently encountered length of a song played on radio music program may be about three or four minutes. A length of an audio segment may also be referred to as a duration. An audiobook chapter may frequently be somewhat longer, such as 11 to 20 minutes. The audio track of a feature film movie may be longer still such as 70 minutes to 210 minutes. Some announcement segments may be very short. For example, an announcement segment ASeg that is a notification tone on a phone may be a fraction of a second to a few seconds. An announcement segment ASeg that is an instruction from a navigation device may be from a few seconds to tens of seconds. However, sometimes an announcement segment may be longer than a program segment. For example, a new alert, a weather warning, a particularly long navigation instruction, and so forth, may be longer than some short program segments.

Absent the benefit of an audio timing apparatus 105, some audio player devices 115 interrupt playback of a program segment PSeg to play an announcement segment ASeg without taking into account that a user may prefer particular program segments PSeg to play uninterrupted until a convenient time. For example, a user may be listening to a program segment PSeg that is a news program, and be interrupted by an announcement segment ASeg that is a notification chime or tone signaling to the user that he or she has received a text message or that an update is available for a particular application. Because the program segment PSeg was interrupted, the user may miss a particular piece of music, or a part of a story in which he or she was interested. Some audio player devices 115 not having the improvements afforded by the audio timing apparatus 105 may simply play an announcement segment ASeg on top of a program segment PSeg if their respective timing windows overlap. Thus, some embodiments may improve the audio player device 115 by including an audio timing apparatus 105 to minimize the interruption of the program segments PSeg by playback of the announcement segments ASeg.

In some embodiments, the audio timing apparatus 105 improves the listen experience of a user of the audio player device 115 by minimizing interruption of the one or more program segments PSeg according to the respective priorities of the one or more program segments PSeg and the priority of the announcement segment ASeg. It may be unusual for a user to configure an audio player device 115 to play a program segment PSeg to interrupt an announcement segment ASeg. Yet, the audio timing apparatus 105 may be configured to operate thus in response to the program segment being designated with a higher priority than the announcement segment and in response to the control module 215 being configured to interrupt the playing of the announcement segment ASeg by playing the program segment PSeg if the timing window of the program segment PSeg overlaps with the timing window of the announcement segment ASeg.

In some embodiments, a short program segment PSeg could be interrupted by a longer announcement segment ASeg. For example, a three-minute program segment PSeg, such as song, being played by audio player device 115 might be interrupted by a five-minute announcement segment ASeg such as a weather alert that provides information about an imminent weather event such as a hurricane where the information may include evacuation instructions and the like.

FIG. 3A depicts a number of program segments PSeg, e.g., PSeg1, PSeg2, and PSeg3. FIG. 3A also depicts program timing windows 310a, 310b, 310c corresponding to scheduled start times and durations of the program segments PSeg1, PSeg2, and PSeg3 respectively. FIG. 3A further depicts an announcement segment ASeg1. FIG. 3A also depicts an unmodified announcement timing window 320a. It may be noted that the depicted lengths of the program segments PSeg and the announcement segment ASeg and their respective timing windows may not be representative of an average length of an announcement segment ASeg relative to average lengths of the one or more program segments PSeg, and are depicted as shown merely for convenience of illustration.

A program segment PSeg or an announcement segment ASeg that is played in a sequence of segments that is modified with respect to the timing of the playing of the segments, may be referenced in the Figures by appending a single prime symbol or a double prime symbol to the end of the PSeg or ASeg reference. In Example A of FIG. 3A, the references ASeg1′ and ASeg1″ may be used to refer to an announcement segment ASeg1 played in a sequence of segments where some aspect of the timing of the playing of one or more of at least one type of segment has been modified by the audio timing apparatus 105.

In some embodiments, the one or more program segments PSeg may include various segment types, such as a streaming music segment, a streaming audiobook segment, a streaming talk segment, a recorded audio segment on a disk, a recorded audio segment on a solid-state storage device, an AM radio broadcast segment, an FM radio broadcast segment, a satellite broadcast segment, a wired auxiliary audio source segment, and/or a wireless auxiliary audio source segment. Some types of the program segments PSeg may be accessed as individual files. The files may include a program segment name, a program segment duration, and other information about each program segment PSeg. Some of the one or more program segments PSeg may include audio intended to provide entertainment, although other program segments PSeg such as news segments or audiobook segments may not necessarily provide entertainment, but may be nonetheless useful.

In some embodiments, the one or more program segments PSeg may be streaming program segments such as audiobook segments, talk segments, and the like. The one or more program segments PSeg may also include AM or FM radio broadcast segments satellite broadcast segments and so forth. Some broadcasts send playlists or other information about current and upcoming program segments PSeg such as start times and lengths.

In some embodiments, the one or more program segments PSeg may come from sources that do not provide digital information about the program segments PSeg. For example, some program segments PSeg may include a wired auxiliary source segment or a wireless auxiliary source segment to be played by the audio player device 115 via an analog cable, such as a stereo cable with 3.5 mm plugs on each end. In response to a source of audio segments not providing information about the length of a particular program segment PSeg, in some embodiments, the program module 205 may further analyze the program segments PSeg to determine song identity, song length, and so forth. In some embodiments, the program module 205 may access another program or another application to identity a song, a song length, and so forth. For example, the program module 205 may access applications such as the Shazam® app for smartphones from Shazam Entertainment Limited, that may digitize and analyze a song being played and identify the song. Once the identity of the song is known, the length of the song may be obtained from any of a number of databases.

In one embodiment, the program module 205 determines one or more program timing windows 310 corresponding to one or more program segments PSeg for playing on the audio player device 115. In some embodiments, program segments PSeg may include, for example, streaming music segments such as songs in a streaming music playlist. Examples of streaming music services that play streaming music segments or songs include Pandora®, Google Play Music®, Spotify® and others. Some streaming music services allow an audio player device 115 to download songs and other audio segments to storage for playing audio segments in the absence of either a wired connection 116 or a wireless connection.

In some embodiments, a program segment PSeg may include a talk show, a news program, and/or a locally accessible audio recording segment. For example, locally accessible audio recording segments may include audio files in any of a number of formats such as MP3, WMA, WAV, OGG, APE, ASF, WMV, and CD audio. In some embodiments, program segments PSeg and or announcement segments ASeg may be locally accessible on CDs, USB memory devices, and/or other storage media. In some embodiments, the program segments PSeg and/or the announcement segments ASeg may be in analog format. For examples, the program segments PSeg and/or the audio segments ASeg may be obtained from AM radio broadcasts, FM radio broadcasts, cassette tape recordings, phonograph records, and the like. It may be noted that the audio timing apparatus 105 may be suitable for use in a wide variety of venues including, for example, vehicle audio players, waiting room sound system audio players, public announcement system audio players, and so forth.

In some embodiments, the program module 205 retrieves a length of the one or more program segments PSeg from a database. In some embodiments, the program module 205 calculates the length of the one or more program segments PSeg from the playback speed, the number of bits to be played back, etc. In some embodiments, a streaming service, radio broadcast service, satellite broadcast service, etc., may broadcast a playlist that includes the name of the one or more program segments PSeg and the length of the one or more program segments PSeg. In another embodiment, the program module 205 may access an index, such as a playlist, menu, etc., that includes song identity and/or song length information. In some embodiments, the program module 205 may determine a program timing window 310 corresponding to a particular program segment PSeg by adding to a reference time t0, the length of each of the one or more program segments PSeg to be played back subsequent to the reference time t0 and prior to playing back the particular program segment PSeg.

For example, referring to FIGS. 3A and 3B, a starting time of program timing window 310c for a particular program segment PSeg3 may be determined to be the reference time t0 plus the length of PSeg1, plus the length of PSeg2. An ending time of the program timing window 310c for program segment PSeg3 may be determined to be the starting time of the timing window 310c plus the length of program segment PSeg3. In some environments, program timing windows 310 may be determined for each of the one or more program segments PSeg, e.g., PSeg1, PSeg2, PSeg3, etc.

In some embodiments, apparatus 200 includes an announcement module 210 that determines an announcement timing window 320 for an announcement segment ASeg for playing on the audio player device 115. It may be noted that an announcement segment ASeg may refer to a singular announcement segment ASeg or may refer to multiple announcement segments ASeg unless otherwise clearly expressed in context. The announcement segment ASeg may be preplanned to be played at a particular time or may occur in response to an event detected by, or transmitted to, an audio player device 115. One example of an announcement segment ASeg may be an audio navigation instruction from the mapping application 154 that may occur in response to the mapping application 154 sensing that a vehicle is approaching a location for which an action is suggested.

For example, an audio navigation instruction may tell a user to take an upcoming exit with enough time to allow the user to steer a vehicle into the correct lane to take the exit. Other examples of announcement segments may include: an audible vehicle warning such as a low fuel warning chime, a seat belt unbuckled chime, a phone call notification, such as a ringtone, a news alert, such as severe weather warning, a text message notification, an email notification, an application notification, an advertisement, and the like. In some embodiments, the announcement segments may include recorded voices, synthesized voices, tones, musical notes, songs chimes, bells, and the like.

In some embodiments, announcement segments ASeg may have standard lengths. For example, radio stations may give advertisers the choice of various lengths for commercial announcement segments ASeg, such as for example: 60 seconds; 30 seconds; 15 seconds; or 10 seconds. Some announcement segments ASeg such as a phone ring tone may have a standard ring cadence such as two seconds of ringing followed by four seconds of silence, or another ring cadence pattern.

In one embodiment, the apparatus 200 includes a control module 215 that analyzes the one or more program timing windows 310 and the announcement timing window 320 and coordinates the playing of the announcement segment ASeg relative to the playing of the one or more program segments PSeg to minimize the interruption of the playing of the one or more program segments PSeg when playing the announcement segment ASeg. In some embodiments, the one or more program timing windows 310 include a scheduled program segment start time, and a program segment duration for the one or more program segments PSeg.

In some embodiments, the scheduled program start time may be obtained from a playlist. The scheduled program start time for a particular program segment PSeg may also be obtained by adding to a current time the length of one or more program segments PSeg scheduled for playback prior to the particular program segment PSeg. The scheduled program end time may be obtained by adding to the scheduled start time of the particular program segment PSeg the length of the particular program segment PSeg.

In some embodiments, the announcement timing window 320 includes an estimated announcement segment start time and an estimated announcement segment duration. In some embodiments, the estimated announcement segment start time of a particular announcement segment ASeg may be a scheduled start time of the announcement segment ASeg. For example, a streaming radio program that provides scheduled start times and durations for program segments PSeg, such as songs, may take into account a start time and duration for an announcement segment ASeg to be played in between some of the program segments PSeg.

In some embodiments, the announcement module 210 may estimate an announcement segment start time of a particular announcement segment ASeg based on information within an application. In one embodiment, the announcement module 210 may interact with an application, such as the mapping application 154 to determine when announcement segments are scheduled to take place and the control module 215 may use scheduled times for the announcement segments to minimize interruption of program segments. For example, for an audio player device 115 in a vehicle traveling at 30 miles an hour where the vehicle is 2 miles away from a suggested exit at a reference time, the announcement module 210 may interact with the mapping application 154 that is using global positioning system (“GPS”) technology, and thus may predict the next estimated announcement start time.

In some embodiments, the control module 215 may either change program segments to avoid the announcement segment from the mapping application 154 or may interact with the mapping application 154 to change the scheduled time of the announcement segment. For example, an initial announcement segment may be “in a half a mile, take the exit” in time to provide at least 60 seconds for a vehicle to enter the exiting lane. To travel 2 miles at 30 miles an hour would be estimated to take four minutes. Accordingly, the estimated start time for the navigation instruction to take the exit would be in the range of about three minutes from the reference time so as to give a driver of the vehicle about one minute's notice to take the exit.

The length of such an announcement segment ASeg that includes the navigation instruction may be, for example, about three seconds. Thus, the announcement module 210 may provide an estimated announcement segment start time and an estimated announcement segment duration. The control module 215 may interact with the mapping application 154 to modify the announcement segment starting time and may instead provide an announcement segment “in a quarter mile, take the exit” in time to provide at least 30 seconds for the vehicle to enter the exit lane in order to finish a program segment that is being played.

In some embodiments, the control module 215 may interact with the mapping application to determine that the estimated announcement segment start time is far enough out in time to allow a longer program segment to be selected and played before the estimated announcement segment start time, thus providing a longer period of uninterrupted programming. The control module 215 may schedule the one or more program segments PSeg according to program segment duration to maximize utilization of time between the scheduled program segment start time of the one or more program segments PSeg and the estimated announcement segment start time of the announcement segment ASeg.

For example, in response to the mapping application 215 determining that a turn is about nine minutes away based on current vehicle speed and distance from the turn, the announcement module 210 may communicate the estimated announcement timing window to the control module 215. In response, the control module 215 may, in some embodiments, modify the order of playing the one or more program segments by selecting an eight-minute program segment, rather than two four-minute program segments. Thus, the audio timing apparatus 105 improves the audio experience by utilizing longer periods of time where no announcement segment ASeg is estimated to start to play longer program segments PSeg without interruption or modification of the program segments themselves.

In some embodiments, the announcement module 210 and the control module 215 interact with an application providing announcement segments to provide a prediction of an announcement segment and also to possibly modify timing of the announcement segments. The control module 215 may delay announcement segments with a lower priority, which may include modification of the announcement segments. The control module 215 may also simply delay lower priority announcement segments without modification of the announcement segments.

In some embodiments, the one or more program timing windows 310 and the announcement timing window 320 each include a priority (In the Figures, the abbreviation “Pri” refers to priority). In some embodiments, the priority may be a categorical code such as high, medium, or low. In some embodiments, the priority of the one or more program segments PSeg and the announcement segment may have numerical values such as one through five, where a lower numerical value indicates a higher priority for a particular segment. Accordingly, a priority of 3 for program segment PSeg1 may be used to indicate program segment PSeg1 has a lower priority than an announcement segment Aseg1 with a priority of 1.

For example, an announcement segment ASeg that is an email notification or a text message notification may have an announcement segment priority lower than a priority of a program segment PSeg that is currently being played back. However, the same announcement segment ASeg that is an email notification or text message notification may have a higher priority than a program segment PSeg that is queued for future playback. Thus, the control module 215 may delay playing the announcement segment ASeg until after the currently playing program segment PSeg is finished, and may play the announcement segment ASeg before playing the next queued program segment PSeg.

In another example, an announcement segment ASeg such as a vehicle warning about a seat belt being unbuckled, or a navigation instruction calling for immediate action, such as “take the exit,” may have a higher priority than a program segment PSeg that is currently being played back. The control module 215 may play the announcement segment ASeg so as to affect the currently playing program segment PSeg, for example, by pausing, ending, modifying, etc., the currently playing program segment PSeg. In one embodiment, priority of an announcement segment is correlated to an amount of tolerated delay. For example, a high priority announcement segment may require no delay or a very short delay, a next lower priority for an announcement segment may allow a minimal amount of delay, a next lower priority of an announcement segment may allow a longer delay, etc. In another embodiment, an announcement segment may include an amount of allowable delay.

In one embodiment, analyzing the one or more program timing windows 310 and the announcement timing window 320 includes determining whether the one or more program segments PSeg overlap with the announcement timing window 320 and determining the priority of the one or more program segments PSeg relative to the announcement segment ASeg. For example, when one of the one or more program segments PSeg has a program timing window 310 that includes a period of time also included in the announcement timing window 320, the one or more program timing windows 310 may be said to overlap with the announcement timing window 320.

The program module 205 and/or the announcement module 210 may respectively analyze the program timing windows 310 and the announcement timing window 320 to help the control module 215 determine if the announcement segment ASeg may be delayed, may be played ahead of a program segment PSeg, may interrupt a currently playing program segment PSeg, and the like. In some embodiments, particular program segments PSeg may include a beginning portion that fades in and/or and ending portion that fades out. In some embodiments, the announcement segment ASeg may overlap the one or more program segments at a fade in portion and/or a fade out portion with minimal impact. Accordingly, the control module 215 may modify the one or more program segments PSeg and/or the announcement segment ASeg only slight or not at all.

In some embodiments, the program segment priority and announcement segment priority may include one or more of a vendor-programmed priority by segment type, a user-programmed priority by segment type, temporary priority by segment type, a user-action-based priority, etc. A vendor may program certain types of announcement segments ASeg to have high priority in situations in which a user's safety or convenience may be impacted if the announcement timing window 320 were to be modified, for example by delayed playing of the announcement segment ASeg. Such high priority announcement segments ASeg may include for example an unbuckled safety belt warning or a navigation instruction calling for immediate action. In some embodiments, the user may be prohibited from modifying a priority of certain announcement segments ASeg.

In some embodiments, the program segment priority and the announcement segment priority may include a user programmed priority by segment type a temporary priority by segment type and a user-action-based priority. More details regarding priorities that involve input from a user will be described below with respect to FIG. 2B.

In one embodiment, further to analyzing the one or more program timing windows 310 and the announcement timing window 320, the control module 215 coordinates the playing of the announcement segment ASeg relative to the playing of the one or more program segments PSeg to minimize the interruption of the playing of the one or more program segments PSeg when playing the announcement segment ASeg.

In some embodiments, to coordinate the playing of the announcement segment ASeg relative to the playback of one or more program segments PSeg, the control module 215 modifies the one or more program segments PSeg in response to the one or more program timing windows 310 overlapping with the announcement timing window 320 and having a lower program segment priority than the announcement segment priority. A more detailed description of exemplary modifications that may be made by the control module 215 to the program segments PSeg and to the announcement segment ASeg is described below with respect to FIGS. 3A and 3B.

FIG. 2B is a schematic block diagram illustrating another embodiment of an apparatus 225 for coordinating playing of audio segments. The apparatus 225 includes another embodiment of an audio timing apparatus 105 that includes a program module 205, an announcement module 210, and a control module 215, that are similar to the program module 205, the announcement module 210, and the control module 215 described above with respect to FIG. 2A.

The apparatus 225 includes a user input module 220 that receives a program segment priority for a program segment PSeg and/or a program segment type, an announcement segment priority for an announcement segment ASeg, and/or an announcement segment type, and may include other user inputs as well. Since different users may have different preferences regarding playback priorities for program segments and announcement segments, the user input module 220 may be useful to enable those preferences to be implemented in the operation of the audio timing apparatus 105.

For example, a user may provide input to the user input module 220 designating that program segments of a particular type, such as for example, audiobooks segments have a higher program segment priority than program segments of a different type, such as for example, music segments. In some embodiments, a user may further provide user input specifying program segment interruption override information to the user input module 220. In one embodiment, the program segment interruption override may provide that a particular program segment is not to be interrupted in response to an announcement segment of a particular type with a higher priority even when the corresponding announcement timing window overlaps the corresponding program timing window, where overlapping refers to simultaneously spanning a finite period of time.

For example, a user may provide input that songs have a lower priority than a phone ring tone. However, there may be times when the user chooses not to be notified of incoming phone calls, but to rather let them go to voicemail. In such a circumstance the user may provide the interruption override for example by pushing a button or icon or by speaking a voice command. In some embodiments, particular announcement types, such as warning signals or other announcement segments geared toward user safety, may interrupt a program segment regardless of the program segment interruption override.

In some embodiments, a user may further provide a priority schedule input to the user input module 220. The priority schedule input may set up priorities associated with particular dates and/or times for the audio player device 115 using the digital clock/calendar 164. For example, a user may normally wish to have incoming phone call type announcement segments delayed until the end of the song, but may be expecting an important phone call to come in at a particular time in which case the user wants announcement segment to interrupt without delay the playing of program segment. Accordingly, the user may provide a priority schedule input to the user input module 220.

In other embodiments, the user input module 220 may accept other user input, such as a ranking of priority of program segments PSeg or program segment types, may accept user input ranking announcement segments ASeg or announcement segment types, may accept user input ranking program segments and announcement segments with respect to each other, or other useful user input. In other embodiments, the user input module 220 may receive user input with regard to particular program segments, such as timing of fade in or fade out, priority of an individual program segment, and the like.

In some embodiments, the user input module 220 may receive user input in the form of a user action such as for example, adjusting volume control 142, pressing power control 144, turning a tuning knob/jog dial 146, inserting a disc into media disc slot 170, and the like. The user input received by way of a user action may initiate a program segment interruption override, or may modify the priority of, for example, a currently playing program segment PSeg or announcement segment ASeg. One of skill in the art will recognize other user input that may be received by the user input module 220, which may affect analyzing and coordinating playing of announcement segments ASeg with respect to program segments PSeg.

FIG. 3A is a schematic block diagram illustrating one embodiment of coordinating playing of audio segments. In some embodiments, the control module 215 may modify the one or more program segments PSeg in response to the one or more program timing windows 310 overlapping with the announcement timing window 320 and having lower program segment priority than the announcement segment priority. In the example of unmodified timing windows depicted in FIG. 3A, an announcement timing window 320a corresponding to announcement segment ASeg1 with the priority of 1 (Pri=1) overlaps with program timing window 310a and 310b which both have a priority of 3.

To improve the audio player device by minimizing unwanted interruption of a program segment PSeg, in some embodiments, the control module 215 may modify the one or more program segments in response to the one or more program timing windows 310a, 310b, and/or 310c overlapping with the announcement timing window 320a; and the one or more program segments PSeg having lower priority than the announcement segment ASeg. In this example, the program segments PSeg1, PSeg2, and PSeg each have a priority of three (Pri=3) which is lower that the priority of the announcement segment ASeg1. Accordingly, the control module 215 may modify the one or more program segments PSeg1, PSeg2, and PSeg3.

In some embodiments, modifying the one or more program segments PSeg may include delaying starting, ending early, fading out, repeating a portion of, switching a playlist order of, time dilating, substituting, and/or editing the one or more program segments PSeg, e.g., PSeg1, PSeg2, and/or PSeg3. Example A depicts a first program segment PSeg1′ which has a modified timing window as a result of ending early and/or fading out early. The ending or fading out early of program segment PSeg 1′ may allow the announcement segment ASeg1′ to maintain the originally intended timing window 320a, as it has a higher priority than the program segment PSeg1′.

Truncating a program segment or an announcement segment, e.g., ending early, may occur abruptly in some embodiments. An abrupt truncation may be less perceptible as an interruption if the program segment PSeg has already played to a point near the intended ending point. Truncating a segment may be especially useful when there is only a small portion of program segment PSeg that has not been played back. An early fadeout may be accomplished by decreasing the volume at a faster rate than, for example, a prerecorded fadeout. Some program segments PSeg, such as some songs, may have very long pre-recorded fadeout portions. Such program segments PSeg may be faded out early with little or no noticeable sense of interruption perceived by a listener. In Example A, the announcement segment ASeg1 maintains its timing window 320a and the second and third program segments PSeg2′ and PSeg3′ as depicted are delayed until after the announcement segment Aseg1′ has completed playing.

In some embodiments, delaying starting of a program segment PSeg may be accomplished by the control module 215 asserting a hold-off signal that is received by an application running on the audio player device 115 or that is received by an application running on a computing device 130. The apparatus receiving the hold off signal may simply delay playback of a program segment PSeg or an announcement segment ASeg until the hold off signal is de-asserted. The hold-off signal may be communicated between an audio player device 115 and a computing device 130 through for example a wired and/or wireless auxiliary connection.

In some embodiments, the control module 215 may have knowledge about the ending of a program segment PSeg such as PSeg1. For example, the control module 215 may analyze the program segment PSeg and determine the point at which the volume begins to gradually decrease indicating a fadeout. The control module 215 may obtain information about the content of the program segment PSeg by accessing data from another source, such as a database. Utilization of content information need not be limited to knowledge about a fadeout. Information about various parts of a song, a talk, or other program segment PSeg may be used to perform intelligent editing of the program segment PSeg.

For example, in some embodiments, an introduction portion of the song may be unedited, as may an ending portion of the song. A middle portion of the song, such as a repetition of a chorus may be omitted. Any technique for editing a song may be applied through the use of processing hardware and software included in the control module 215. In some embodiments, the control module 215 may communicate with a local application on the audio player device 115 or with the remote application on another computing device 130 to request and obtain editing of one or more program segments PSeg and/or the announcement segment ASeg.

Example B of FIG. 3A depicts modifying the timing of a first program segment PSeg1″ and a second program segment PSeg2″ involving switching the order of the playing of the segments so that the second program segment PSeg2″, which is shorter, is played first so that the timing window of the announcement segment Aseg1″ may be maintained. What was originally the first program segment may then be played after the announcement segment completes playing.

Another method of modifying by substituting may be to substitute a shorter version of the program segment PSeg for the originally planned version of the program segment PSeg. For example, the control module may substitute a “radio edit” version which is a modified and often shortened version, to make a song more suitable for airplay. In some embodiments, the audio timing apparatus 105 may retrieve truncated versions such as radio edit versions of songs from a server 135 over the data network 110.

A shorter second program segment PSeg may be substituted for a longer first program segment in order to accommodate a particular program timing window 310. Similarly, a second announcement segment ASeg may be substituted for a first announcement segment ASeg to accommodate particular announcement timing window. Shorter announcement segments may sometimes be referred to as interstitial material. In some embodiments, one or more of announcement segments ASeg may have been delayed and/or may be waiting in queue to be played back. Thus, if content to be played back is needed to fill a gap in time between the end of a currently playing program segment and the next program timing window 310, one or more of the announcement segments ASeg of an appropriate length to fill the time gap may be played.

FIG. 3B is a schematic block diagram illustrating another embodiment of coordinating playing of audio segments. FIG. 3B depicts additional examples of modifying the timing of the playing of the one or more program segments PSeg relative to the timing of the playing of the announcement segment ASeg. In some embodiments, the control module 215 modifies the announcement segment ASeg in response to the announcement timing window 320 overlapping with the one or more program timing windows 310 and the announcement segment ASeg not having higher priority than the one or more program segments PSeg, For example, as depicted in FIG. 3B the unmodified timing windows for Examples C and D so that the announcement timing window 320b of announcement segment ASeg2 (Pri=2) overlaps with the program timing window 310d of program segment PSeg4 and announcement segment ASeg2 (Pri=2) does not have a higher priority than the program segment PSeg4 (Pri=1).

In Example C, the program segment PSeg4 with its higher priority (Pri=1) maintains its unmodified timing window 310d and the announcement segment ASeg2 is modified by delaying it until the program segment PSeg4 has completed playing. In some embodiments, modifying may include time dilating which may include stretching and/or compressing along with corrective adjustments to pitch. Time dilating may also be known as time-scale modification or time stretching. Time dilating as used herein may refer to changing the playing speed of an audio segment.

Time dilation, also referred to as time-stretching or time compression, may be performed using frequency domain signal processing techniques such as phase vocoder techniques or sinusoidal spectral modeling or time domain signal processing techniques such as synchronized overlap-add method or time-domain harmonic scaling. Thus as depicted in Example C, the announcement segment ASeg2′ may further be modified by expanding the announcement segment ASeg (which is then referred to as ASeg2′) to fill the gap in time between its delayed starting time and the starting time of the next scheduled segment, i.e., program segment PSeg5′.

Another type of modifying is illustrated in Example C where the unmodified timing window 310e of program segment PSeg5 overlaps with the timing window 320c of announcement segment ASeg3. In this case, the control module 215 receives information about the announcement timing window 320c for announcement segment ASeg3 including that the announcement segment ASeg3 has a higher priority (Pri=2) than the program segment PSeg5 (Pri=3). In this example, the program segment PSeg5′ had already started playing at the time the overlap of the timing windows 310e, 320c was detected by the control module 215. This may occur for example, in a situation in which, after the program segment PSeg5 had partially played, an announcement segment Aseg3 in the form of an incoming phone call notification tone was received and analyzed by the announcement module 210.

The control module 215 may determine that the program timing window 310e and the announcement timing window 320c overlap and that the priority for program segment PSeg5 is lower than the priority of the announcement segment ASeg3. Thus, the control module may pause the program segment PSeg5′ so that it can play the higher priority announcement segment ASeg3′ in a timely manner, i.e., maintain the timing window 320c unmodified. After the announcement segment ASeg3′ concludes playing the control module may un-pause the program segment PSeg5′ and continue playing it.

In some embodiments, the control module 215 may modify the playing of the program segment PSeg by editing. Editing may include, for example, modifying in some way the content of the program segment PSeg and/or an announcement segment ASeg. For example, the control module 215 may repeat the playing of an earlier played portion of the program segment PSeg5′ so that a listener may more comfortably understand the context of the continued portion. This may be a situation, for example, in which program segment PSeg5 is from an audiobook which was paused in the middle of a sentence or paragraph in order to accommodate the higher priority announcement segment ASeg3. Thus, the control module 215 may repeat a starting portion of the sentence or paragraph so as to provide a more comfortable listening experience for the listener when the audio player device 115 returns to playing of the program segment PSeg5′.

FIG. 3B also depicts example D, in which, in response to the overlap between the program segment Pseg4″ having a higher priority (Pri=1) than the priority of the announcement segment ASeg2, the control module 215 delays the start of the announcement segment ASeg2″. The control module 215 may also recognize a potential for a gap in playing if the first announcement segment ASeg2″ were played back at normal speed. Thus, the control module 215 may compress the first announcement segment ASeg2″ using time dilation as previously described. The compression may be accomplished, for example, by speeding up the playing of the announcement segment ASeg2″ while lowering the frequency of the pitch so that it sounds more natural. Compressing the announcement segment ASeg 2″ may allow for a second announcement segment Aseg3″ to be played earlier than it would have otherwise been played (e.g., with a new announcement timing window 320d) and prior to beginning playback of a longer program segment PSeg5″. Thus, no gap occurs and program segment PSeg5″ may be maintained in its unmodified program timing window 310e.

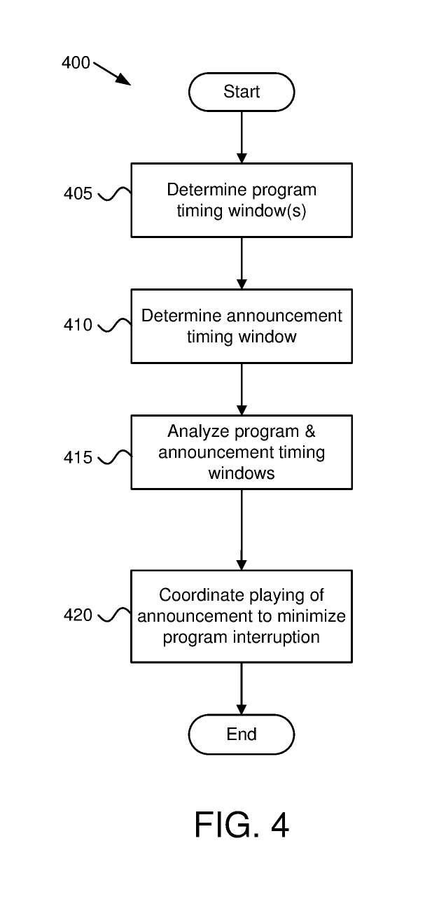

FIG. 4 is a schematic flow chart diagram illustrating one embodiment of an audio playback segment coordination method. The method 400 begins and determines 405 one or more program timing windows 310 corresponding to one or more program segments PSeg for playing on an audio player device 115. The method 400 determines 410 an announcement timing window 320 for an announcement segment ASeg for playing on the audio player device 115. The method 400 analyzes 415 the one or more program timing windows 310 and the announcement timing window 320 and coordinates 420 the playing of the announcement segment ASeg relative to the playing of the one or more program segments PSeg to minimize an interruption of the playing of the one or more program segments PSeg when playing the announcement segment ASeg, and the method 400 ends.

In some embodiments, analyzing the one or more program timing windows 310 and the announcement timing window 320 may include determining whether the one or more program segments PSeg overlaps with the announcement segment ASeg and determining the relative priority of the one or more program segments PSeg and the announcement segment ASeg. Based on the analysis, the method 400 coordinates 420 the playing of the announcement segment ASeg relative to the playing of the one or more program segments PSeg to minimize an interruption of the playing of the one or more program segments PSeg when playing the announcement segment ASeg. In some embodiments, the steps of method 400 performed by the program module 205, the announcement module 210, and/or the control module 215.

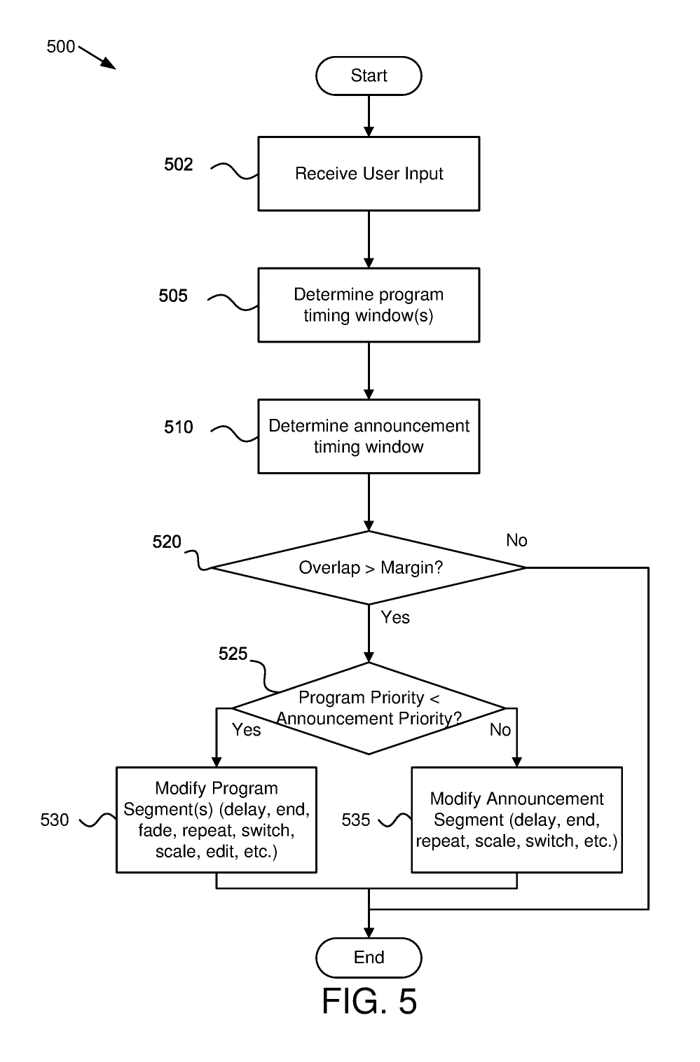

FIG. 5 is a schematic flow chart diagram illustrating another embodiment of an audio playback segment coordination method. The method 500 begins and receives 502 user input. The user input may be used in carrying out the steps of method 500 and may include a program segment priority for a program segment PSeg and/or a program segment type, an announcement segment priority for an announcement segment ASeg and an announcement segment type, a program segment interruption override, and/or a priority schedule.

The method 500 determines 505 one or more program timing windows 310 corresponding to one or more program segments PSeg for playing on an audio player device 115. Determining the one or more program timing windows 310 corresponding to a program segment PSeg may include obtaining an estimated or scheduled starting time and an estimated or actual duration of the program segment PSeg. For example, the method 500 may obtain a playlist that includes program segment names, program segment start-times, and/or program segment durations or lengths. The method 500, in some embodiments, may determine 510 an announcement timing window 320 for an announcement segment ASeg for playing on the audio player device 115.

In some embodiments, the method 500 analyzes the one or more program timing windows 310 and the announcement timing window 320. In some embodiments, the method 500 may determine 520 whether the one or more program segments PSeg overlap with the announcement timing window ASeg. For example, when the announcement timing window 320 for the announcement segments ASeg spans the same period of time as the one or more program timing windows 320 for the one or more program segments PSeg, the announcement segment timing window may be said to overlap with the one or more program timing windows 310 for the one or more program segments PSeg. If the method 500 determines that the one or more program timing windows 310 do not overlap with the announcement timing window 320, the method 500 ends.

If the method 500 determines 520 that the one or more program timing windows 310 overlaps with the announcement timing window 320, the method 500 determines 525 whether priorities of one or more program segments PSeg are lower than the priority of the announcement segment ASeg. If the method determines that the priorities of the one or more program segments PSeg are lower than the priority of the announcement segment ASeg, the method 500 modifies 530 the one or more program segments PSeg, and the method 500 ends. If the priorities of the one or more program segments PSeg are not lower than the announcement priority, the method 500 modifies 535 the announcement segment ASeg, and the method 500 ends. In one embodiment, the program module 205, the announcement module 210, the control module 215, and the user input module 220 perform one or more steps of the method 500.

In some embodiments, one or more steps of method 400 and/or one or more steps of method 500 may be performed by a program product including a computer readable storage medium that stores code executable by a processor, the executable code comprising code to perform one or more steps of method 400 and/or method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a program module that determines one or more program timing windows corresponding to one or more program segments for playing on an audio player device;
an announcement module that determines an announcement timing window for an announcement segment for playing on the audio player device; and
a control module that analyzes the one or more program timing windows and the announcement timing window and coordinates the playing of the announcement segment relative to the playing of the one or more program segments to minimize an interruption of the playing of the one or more program segments when playing the announcement segment.

2. The apparatus of claim 1, wherein the one or more program timing windows each comprise a program segment priority for the one or more program segments and the announcement timing window comprises an announcement segment priority for the announcement segment.

3. The apparatus of claim 2, wherein the program segment priority and announcement segment priority comprise one or more of a vendor-programmed priority by segment type, a user-programmed priority by segment type, temporary priority by segment type, and a user-action-based priority.

4. The apparatus of claim 2, wherein analyzing the one or more program timing windows and the announcement timing window comprises determining whether the one or more program timing windows overlap with the announcement timing window and determining the priority of the one or more program segments relative to the announcement segment.

5. The apparatus of claim 2, wherein responsive to a program timing window having a first priority overlapping with an announcement timing window having a second priority, the control module:
modifies a program segment corresponding to said program timing window when said first priority is less than said second priority; and
modifies the announcement segment when said second priority is not higher than said first priority.

6. The apparatus of claim 5, wherein
modifying the one or more program segments comprises one or more of delaying starting, truncating, fading out, repeating a portion of, substituting, switching playing order, time dilating, and editing the one or more program segments; and
modifying the announcement segment comprises one or more of delaying starting, truncating, repeating a portion of, time dilating, switching playing order of, and substituting the announcement segment.

7. The apparatus of claim 1, further comprising a user input module that receives one or more of:
a program segment priority for one or more of a program segment and a program segment type;
an announcement segment priority for an announcement segment and an announcement segment type;
a program segment interruption override; and
a priority schedule.

8. The apparatus of claim 1, wherein the one or more program segments comprise one or more of a streaming music segment, a streaming audiobook segment, a streaming talk segment, an audio segment on a disk, an audio segment on a solid-state storage device, an AM radio broadcast segment, an FM radio broadcast segment, a satellite broadcast, a wired auxiliary audio source segment, and a wireless auxiliary audio source segment.

9. The apparatus of claim 1, wherein the announcement segment comprises one or more of a vehicle warning, a navigation instruction, a phone call notification, a news alert, a text message notification, an email notification, a paging message, an application notification, and an advertisement.

10. The apparatus of claim 1 wherein:
the one or more program timing windows comprise a scheduled program segment start time, and a program segment duration for the one or more program segments; and
the announcement timing window comprises an estimated announcement segment start time and an estimated announcement segment duration.

11. The apparatus of claim 10, wherein one or more of:
the announcement module interacts with an application providing an announcement segment to determine a schedule for the announcement segment; and
the control module interacts with an application to modify one or more of timing of an announcement segment and content of the announcement segment.

12. A method comprising:
determining one or more program timing windows corresponding to one or more program segments for playing on an audio player device;
determining an announcement timing window for an announcement segment for playing on the audio player device;
analyzing the one or more program timing windows and the announcement timing window; and
coordinating the playing of the announcement segment relative to the playing of the one or more program segments to minimize an interruption of the playing of the one or more program segments when playing the announcement segment.

13. The method of claim 11, wherein the one or more program timing windows each comprise a program segment priority and the announcement timing window comprises an announcement segment priority.

14. The method of claim 13, wherein the program segment priority and announcement segment priority comprise one or more of a vendor-programmed priority by segment type, a user-programmed priority by segment type, temporary priority by segment type, and a user-action-based priority.

15. The method of claim 11, wherein analyzing the one or more program timing windows and the announcement timing window comprises determining whether the one or program segments overlap with the announcement timing window and determining a priority of the one or more program segments relative to the announcement segment.

16. The method of claim 15, further comprising one or more of:
modifying the one or more program segments in response to:
the one or more program timing windows overlapping with the announcement timing window; and
the one or more program segments having lower priority than the announcement segment; and
modifying the announcement segment in response to:
the announcement timing window overlapping with the one or more program timing windows; and
the announcement segment not having higher priority than the one or more program segments.

17. The method of claim 16, wherein:
modifying the one or more program segments comprises one or more of delaying starting, truncating, fading out, repeating a portion of, substituting, switching playing order, time dilating, and editing the one or more program segments; and
modifying the announcement segment comprises one or more of delaying starting, truncating, repeating a portion of, time dilating, switching playing order of, and substituting the announcement segment.

18. The method of claim 11, further comprising receiving user input comprising one or more of:
a program segment priority for one or more of a program segment and a program segment type;
an announcement segment priority for an announcement segment and an announcement segment type;
a program segment interruption override; and
a priority schedule.

19. A program product comprising a computer readable storage medium that stores code executable by a processor, the executable code comprising code to perform:
determining one or more program timing windows corresponding to one or more program segments for playing on an audio player device;
determining an announcement timing window for an announcement segment for playing on the audio player device;
analyzing the one or more program timing windows and the announcement timing window; and
coordinating the playing of the announcement segment relative to the playing of the one or more program segments to minimize an interruption of the playing of the one or more program segments when playing the announcement segment.

20. The program product of claim 19, wherein coordinating the playing of the announcement segment relative to the playing of the one or more program segments comprises:
modifying the one or more program segments in response to:
the one or more program timing windows overlapping with the announcement timing window; and
the one or more program segments having a lower priority than the announcement segment; and
modifying the announcement segment in response to:
the announcement timing window overlapping with the one or more program timing windows; and
the announcement segment not having a higher priority than the one or more program segments.
